(19) United States
(12) Patent Application Publication
(10) Pub. No.: US 2021/0079722 A1
(43) Pub. Date: Mar. 18, 2021

(54) CORD-PENETRATING COMPONENT FOR USE WITH WINDOW SHADE AND WINDOW SHADE USING THE CORD-PENETRATING COMPONENT

(71) Applicant: CHING FENG HOME FASHIONS CO., LTD., FUXING TOWNSHIP (TW)

(72) Inventor: Wen-Ying LIANG, FUXING TOWNSHIP (TW)

(73) Assignee: CHING FENG HOME FASHIONS CO., LTD., FUXING TOWNSHIP (TW)

(21) Appl. No.: 16/657,435

(22) Filed: Oct. 18, 2019

(30) Foreign Application Priority Data
Sep. 12, 2019 (TW) 108212153

(51) Int. Cl. E06B 9/322

(52) U.S. Cl. CPC E06B 9/322

(57) ABSTRACT

Provided is a cord-penetrating component for use with a window shade having a top rail, a reeling unit and a cord. A bottom wall of the top rail has a through-hole penetrable by the cord. The reeling unit is disposed in the top rail and has a top plate and a bottom plate. A reeling wheel for reeling in the cord is disposed between the top and bottom plates. The cord-penetrating component is disposed on bottom wall of the top rail and protrudes from top side of the bottom wall. Ratio of vertical distance between bottom side of the top plate of the reeling unit and top side of the bottom plate of the reeling unit to vertical distance between top side of the cord-penetrating component and top side of the bottom wall of the top rail is 2−5:1. A window shade using the cord-penetrating component is further provided.

### BACKGROUND OF THE INVENTION

### 1. Technical Field

The present disclosure relates to window shades and, more particularly, to a cord-penetrating component for use with a window shade and a window shade using the cord-penetrating component.

### 2. Description of Related Art

In general, as shown in FIG. 1, a conventional window shade with hidden cords reels in left and right cords 95 with a reeling unit 92 disposed in a top rail 90. Since one end of each of the left and right cords 95 is fastened to a bottom rail, the bottom rail rises gradually while the left and right cords 95 are being reeled in; hence, a blind is folded because of the rise of the bottom rail.

A bottom wall 91 of the top rail 90 usually has a cord-penetrating component 96 penetrable by the cords 95. The cord-penetrating component 96 guides the cords 95 such that the cords 95 are smoothly let out and reeled in. The cord-penetrating component 96 and top and bottom plates 93, 94 of the reeling unit 92 are positioned at the three vertices of a right triangle, respectively, as shown in FIG. 2; as a result, the cords 95 from different coils are likely to interfere with each other or become twisted together while the cords 95 are being wound onto the reeling unit 92 under the guidance of the cord-penetrating component 96. If the aforesaid phenomenon is severe, the cords 95 cannot be smoothly let out and reeled in or are even stuck; as a result, the blind ends up with a tilted bottom or even cannot be completely unfolded or folded to the detriment of user experience.

### BRIEF SUMMARY OF THE INVENTION

It is an objective of the present disclosure to provide a cord-penetrating component for use with a window shade, so as to not only allow a cord to be reeled in smoothly and neatly but also allow a blind of the window shade to be unfolded and folded steadily.

In order to achieve the above and other objectives, the present disclosure provides a window shade comprises a top rail, a reeling unit and a cord. The top rail has a bottom wall. The bottom wall has a through hole penetrable by the cord. The reeling unit is disposed in the top rail and has a top plate, a bottom plate and a reeling wheel disposed between the top plate and the bottom plate. One end of the cord is disposed at the reeling wheel such that the cord is driven by the reeling wheel and thus wound onto the reeling wheel. The cord-penetrating component is disposed at the bottom wall of the top rail and protrudes from a top side of the bottom wall of the top rail. The cord-penetrating component has a guide hole penetrable by the cord. The vertical distance between the bottom side of the top plate of the reeling unit and the top side of the bottom plate of the reeling unit is denoted by H1, whereas the vertical distance between the top side of the cord-penetrating component and the top side of the bottom wall of the top rail is denoted by H2, where H1:H2=2−5:1.

Therefore, according to the present disclosure, given a specific ratio of the height of the cord-penetrating component to the height of the reel, not only are the cords wound onto the reeling wheel steadily and smoothly, but the cords from different coils are also unlikely to interfere with each other or become twisted together, thereby allowing the blind of the window shade to be unfolded and folded steadily.

In the first embodiment of the present disclosure, the cord-penetrating component has an annular wall, at least two opposing first arcuate peripheral walls and at least two opposing second arcuate peripheral walls. The annular wall has the guide hole. The at least two first arcuate peripheral walls and the at least two second arcuate peripheral walls alternately connect to the outer edge of the annular wall. The at least two first arcuate peripheral walls are of a larger outer diameter than the at least two second arcuate peripheral walls. The bottom ends of the at least two first arcuate peripheral walls abut against the top side of the bottom wall of the top rail. The bottom ends of the at least two second arcuate peripheral walls each have an extension portion and a hook portion extending outward from the terminal end of the extension portion. To be mounted on the top rail, the cord-penetrating component presses the extension portions of the at least two second arcuate peripheral walls downward into the through holes of the bottom wall of the top rail to allow the hook portions of the at least two second arcuate peripheral walls to pass through the through holes and engage with the bottom side of the bottom wall of the top rail.

In the second embodiment of the present disclosure, the cord-penetrating component has an annular wall and a peripheral wall. The annular wall has the guide hole. The peripheral wall connects to the outer edge of the annular wall. The peripheral wall has at least two opposing slits. The at least two slits extend from the bottom end of the peripheral wall toward the annular wall such that a resilient wing is formed between the at least two slits. The bottom end of the peripheral wall further has an extension portion and a blocking flange extending outward from the terminal end of the extension portion. To be mounted on the top rail, the cord-penetrating component is pressed upward into the through hole of the bottom wall of the top rail to not only allow the resilient wing of the peripheral wall to pass through the through hole and expand outward so as to engage with the top side of the bottom wall of the top rail, but also allow the blocking flange of the peripheral wall to engage with the bottom side of the bottom wall of the top rail.

Fine structures, features, assembly or operation of a cord-penetrating component for use with a window shade and a window shade using the cord-penetrating component, provided according to the present disclosure, are illustrated by embodiments and described below. However, persons skilled in the art understand that the description below and the specific embodiments are illustrative of the present disclosure rather than restrictive of the claims of the present disclosure.

### BRIEF DESCRIPTION OF THE SEVERAL VIEWS OF THE DRAWINGS

FIG. 1 (PRIOR ART) is a perspective view of a conventional cord-penetrating component operating in conjunction with a window shade.

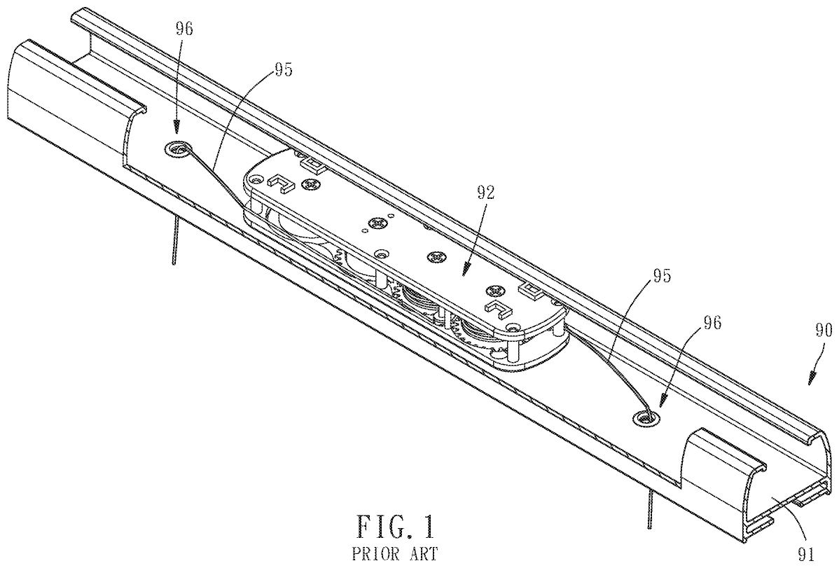

FIG. 2 (PRIOR ART) is a front view of FIG. 1.

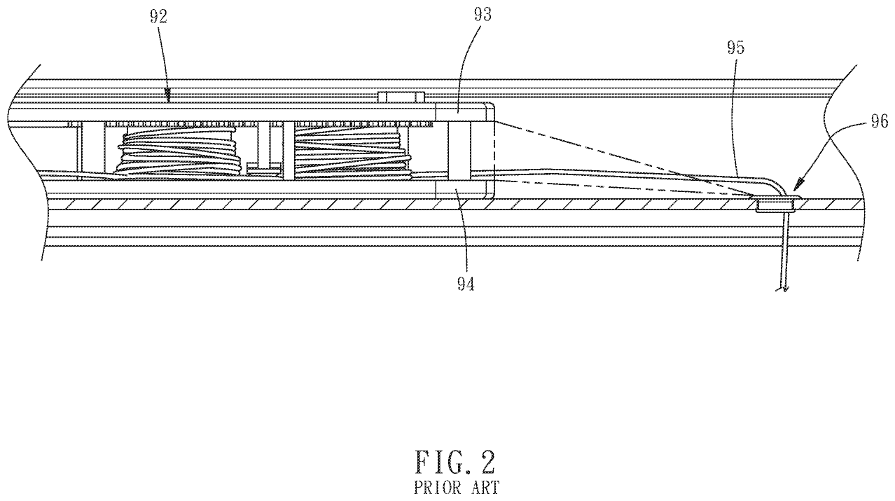

FIG. 3 is a perspective view of a cord-penetrating component operating in conjunction with a window shade according to the first embodiment of the present disclosure, showing a blind unfolded.

FIG. 4 is similar to FIG. 3 and shows the blind in a folded state.

FIG. 5 is a perspective view of the cord-penetrating component according to the first embodiment of the present disclosure.

FIG. 6A and FIG. 6B are schematic views of the cord-penetrating component mounted on a top rail according to the first embodiment of the present disclosure.

FIG. 7 is a cross-sectional view of the cord-penetrating component mounted on the top rail according to the first embodiment of the present disclosure.

FIG. 8 is a front view of the cord-penetrating component operating in conjunction with a reeling unit and a cord according to the first embodiment of the present disclosure, showing the structural relationship between the cord-penetrating component and the reeling unit when the blind is folded.

FIG. 9 is similar to FIG. 8 and shows the structural relationship between the cord-penetrating component and the reeling unit when the blind is unfolded.

FIG. 10 is a front view of the cord-penetrating component operating in conjunction with the reeling unit according to the first embodiment of the present disclosure, showing the distance between an annular wall of the cord-penetrating component and a guide rod of the reeling unit.

FIG. 11 is a perspective view of the cord-penetrating component according to the second embodiment of the present disclosure.

FIG. 12A and FIG. 12B are schematic views of the cord-penetrating component mounted on the top rail according to the second embodiment of the present disclosure.

FIG. 13 is a cross-sectional view of the cord-penetrating component mounted on the top rail according to the second embodiment of the present disclosure.

### DETAILED DESCRIPTION OF THE INVENTION

Directional expressions used herein, including the description of embodiments and claims, must be interpreted in accordance with the accompanying drawings. Identical reference numerals used in the embodiments and the accompanying drawings denote identical or similar components or structural features thereof.

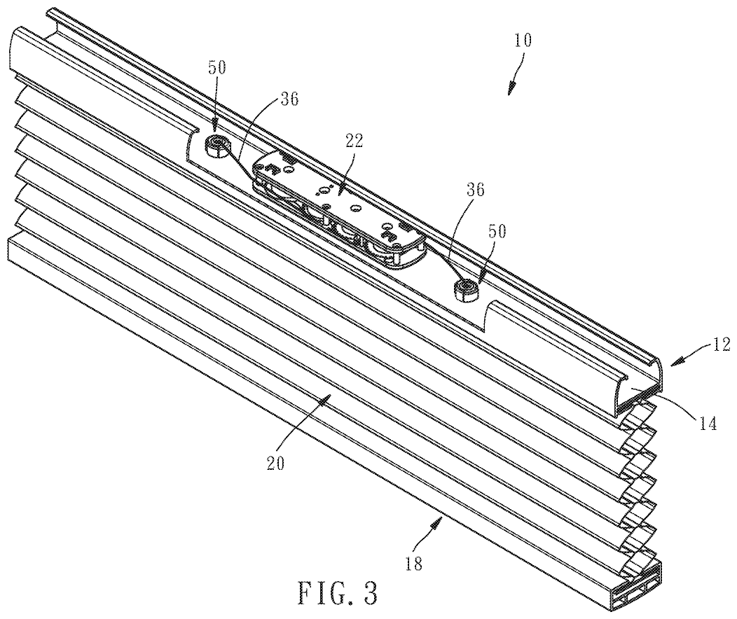

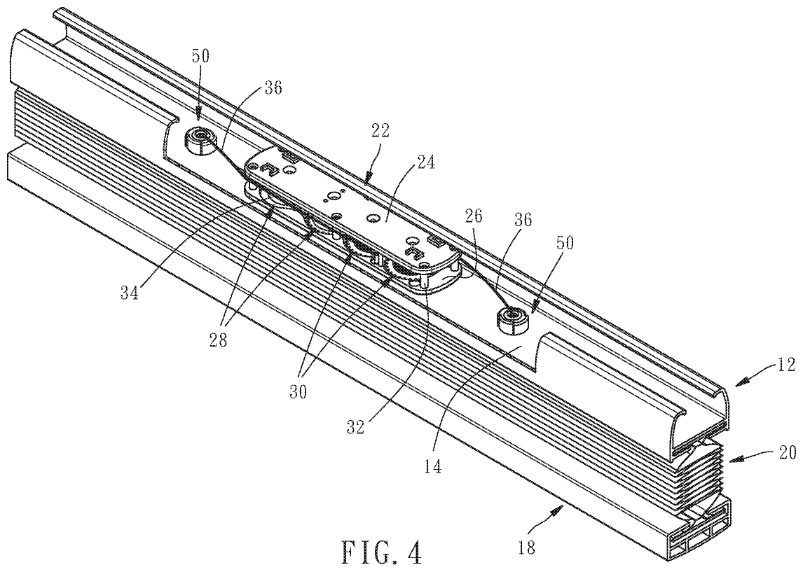

Referring to FIG. 3 and FIG. 4, a window shade 10 comprises a top rail 12, a bottom rail 18, a blind 20, a reeling unit 22 and two cords 36.

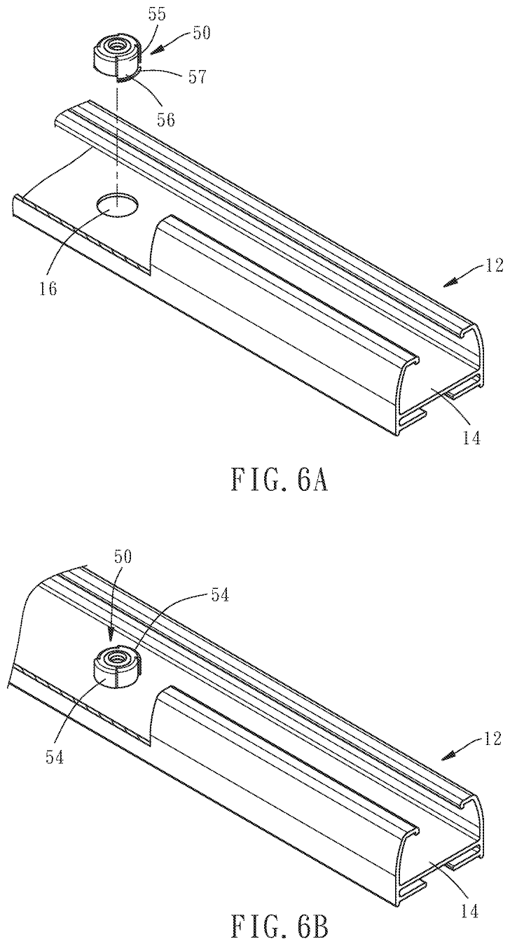

The top rail 12 has a bottom wall 14. The bottom wall 14 has a through hole 16 penetrating the bottom wall 14 (as shown in FIG. 6B).

The blind 20 (which is a cellular blind, but the present disclosure is not limited thereto) is disposed between the top rail 12 and bottom rail 18.

The reeling unit 22 is disposed in the top rail 12 and has a top plate 24, a bottom plate 26, two driving wheels 28 and two reeling wheels 30. The top plate 24 and bottom plate 26 are connected by support posts 32. The two driving wheels 28 are each paired with a corresponding one of the two reeling wheels 30 in order to attain synchronous operation thereof. A volute spring 34 is disposed between the two driving wheels 28. The two reeling wheels 30 are each connected to one end of one said cord 36. The other end of one said cord 36 passes through the blind 20 and the through hole 16 of the bottom wall 14 of the top rail 12 and then connects to the bottom rail 18. Therefore, as soon as the two driving wheels 28 rotate under a resilient restoring force exerted by the volute spring 34, the two driving wheels 28 drive the two reeling wheels 30 to rotate such that the two cords 36 are wound onto the two reeling wheels 30 and thus drive the bottom rail 18 to move upward. The upward movement of the bottom rail 18 causes the blind 20 to fold up.

The constituent elements of the window shade 10 are conventional elements and thus, for the sake of brevity, are not described herein.

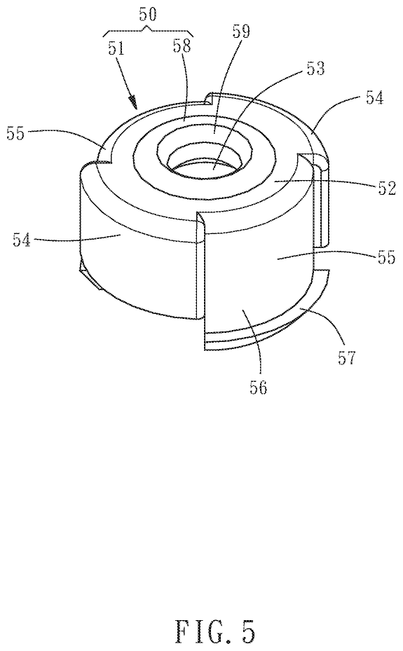

Referring to FIG. 5, in the first embodiment of the present disclosure, a cord-penetrating component 50 has a plastic body 51. The plastic body 51 has an annular wall 52, two opposing first arcuate peripheral walls 54 (which are enough, though three or more are feasible as well) and two opposing second arcuate peripheral walls 55 (which are enough, though three or more are feasible as well). The annular wall 52 surrounds a guide hole 53 which penetrates the top and the bottom of the cord-penetrating component 50. The two first arcuate peripheral walls 54 and the two second arcuate peripheral walls 55 alternately connect to the outer edge of the annular wall 52. The two first arcuate peripheral walls 54 are of a larger outer diameter than the two second arcuate peripheral walls 55. The bottom ends of the two second arcuate peripheral walls 55 each have an extension portion 56 and a hook portion 57 extending outward from the terminal end of the extension portion 56. In the first embodiment of the present disclosure, the cord-penetrating component 50 further has an annular element 58 made of a metallic material. The annular element 58 is disposed on the annular wall 52 of the plastic body 51 and has a chamfer portion 59 surrounding the guide hole 53. The chamfer portion 59 reduces the friction between it and the cords 36 and thus enhances the smoothness of the operation of the cords 36.

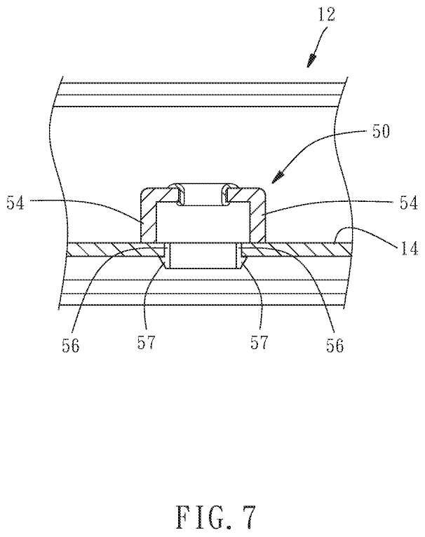

Referring to FIG. 6A, FIG. 6B and FIG. 7, to be mounted on the top rail 12, the cord-penetrating component 50 presses the extension portions 56 of the two second arcuate peripheral walls 55 downward into the through holes 16 of the bottom wall 14 of the top rail 12 to not only allow the hook portions 57 of the two second arcuate peripheral walls 55 to pass through the through holes 16 and engage with the bottom side of the bottom wall 14 of the top rail 12, but also allow the bottom ends of the two first arcuate peripheral walls 54 to abut against the top side of the bottom wall 14 of the top rail 12. At this point, the cord-penetrating component 50 is fixed in place.

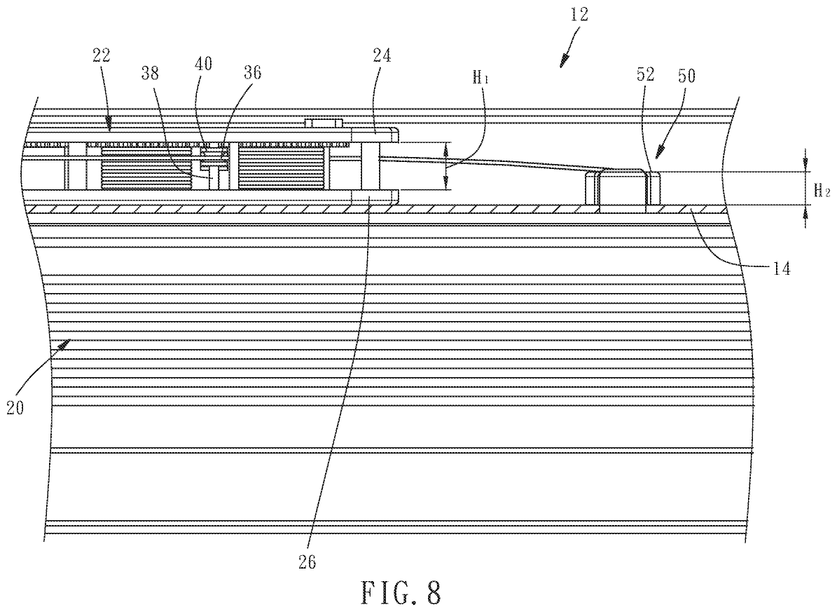

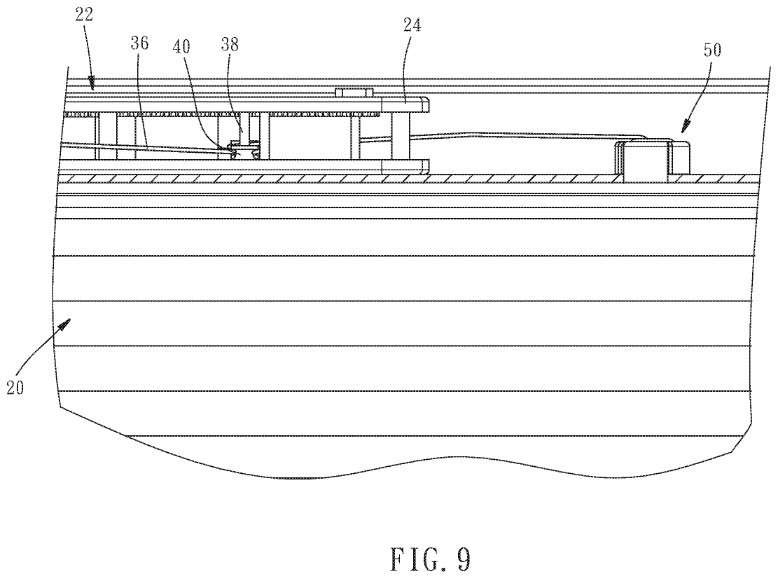

Referring to FIG. 8 and FIG. 9, after the cord-penetrating component 50 has been fixed in place, the relationship between the cord-penetrating component 50 and the reeling unit 22 satisfies the relation H1:H2=2−5:1. H denotes the vertical distance between the bottom side of the top plate 24 of the reeling unit 22 and the top side of the bottom plate 26 of the reeling unit 22. H2 denotes the vertical distance between the top side of the annular wall 52 of the cord-penetrating component 50 and the top side of the bottom wall 14 of the top rail 12. The most preferable ratio of H1 to H2 is 2:1.

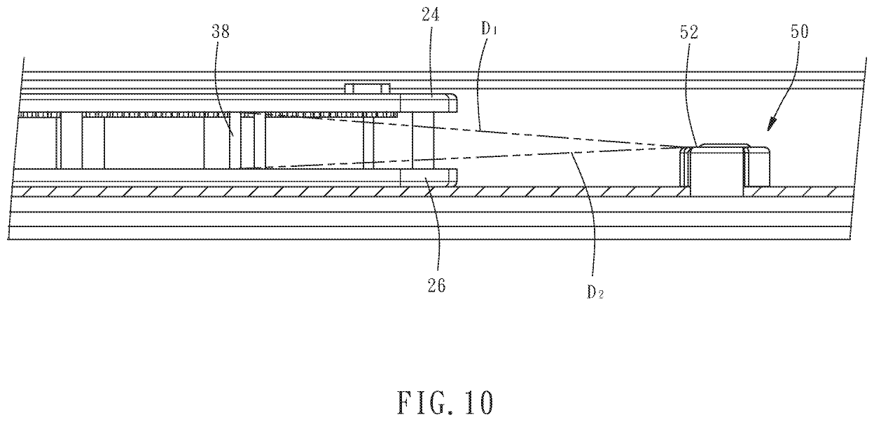

To further enhance the smoothness of reeling the cords 36 in, two guide rods 38 are disposed between the top plate 24 and the bottom plate 26. The two guide rods 38 are disposed between the two reeling wheels 30 and aligned therewith. A guide wheel 40 for guiding the cords 36 fits around each said guide rod 38. Therefore, as the cords 36 are being let out of the reeling wheels 30, i.e., in the course of the unfolding of the blind 20, the guide wheels 40 are driven by the cords 36 to undergo reciprocating motion vertically in the axial direction of the guide rods 38. As shown in FIG. 9, as soon as the blind 20 is completely unfolded, the guide wheels 40 are located at the bottom ends of the guide rods 38 and abut against the top side of the bottom plate 26. Conversely, as soon as the cords 36 are wound onto the reeling wheels 30, i.e., in the course of the folding of the blind 20, the guide wheels 40 are driven by the cords 36 to undergo reciprocating motion vertically in the axial direction of the guide rods 38. As shown in FIG. 8, as soon as the blind 20 is completely folded, the guide wheels 40 are located at the top ends of the guide rods 38 and abut against the bottom side of the top plate 24. Referring to FIG. 10, the relationship between the cord-penetrating component 50 and the reeling unit 22 satisfies the relation D1≅D2, wherein D1 denotes the distance between the top side of the annular wall 52 of the cord-penetrating component 50 and the junction of the guide rods 38 and the top plate 24, and D2 denotes the distance between the top side of the annular wall 52 of the cord-penetrating component 50 and the junction of the guide rods 38 and the bottom plate 26 such that the top and bottom plates 24, 26 and the annular wall 52 of the cord-penetrating component 50 are positioned at the three vertices of an isosceles triangle, respectively. The guide wheels 40 are dispensable as needed, and in consequence the cords 36 directly pass the guide rods 38, then connect to the reeling wheels 30, and finally move vertically in direction of the guide rods 38 in the course of the unfolding and folding of the blind 20.

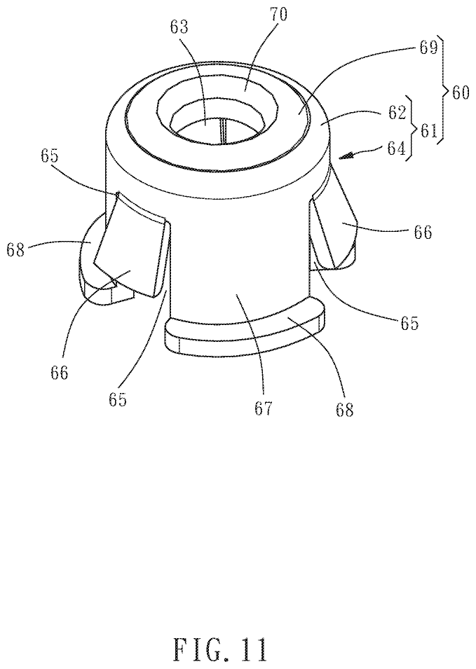

Referring to FIG. 11, in the second embodiment of the present disclosure, a cord-penetrating component 60 has a plastic body 61. The plastic body 61 has an annular wall 62 and a peripheral wall 64. The annular wall 62 has a guide hole 63 which penetrates the annular wall 62. The peripheral wall 64 connects to the outer edge of the annular wall 62. The peripheral wall 64 has three pairs of slits 65. Each pair of slits 65 extend from the bottom end of the peripheral wall 64 toward the annular wall 62 such that a resilient wing 66 is formed between each pair of slits 65. The bottom end of the peripheral wall 64 has an extension portion 67 between two adjacent resilient wings 66. A blocking flange 68 extends outward from the terminal end of each extension portion 67. In the second embodiment of the present disclosure, the cord-penetrating component 60 further has an annular element 69 made of a metallic material. The annular element 69 is disposed on the annular wall 62 of the plastic body 61 and has a chamfer portion 70 surrounding the guide hole 63.

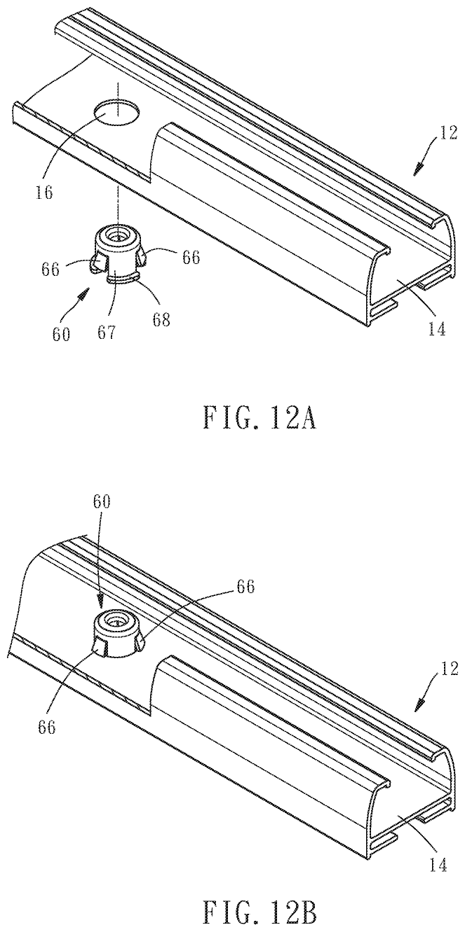

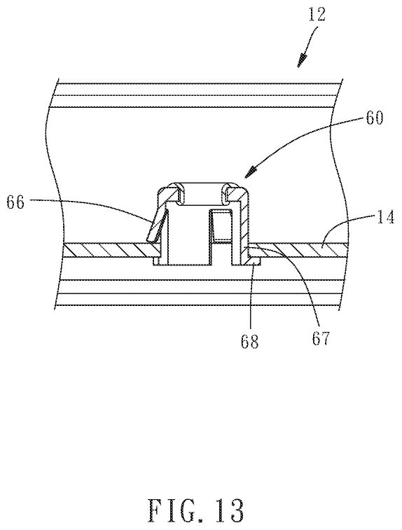

Referring to FIG. 12A, FIG. 12B and FIG. 13, to be mounted on the top rail 12, the cord-penetrating component 60 is pressed upward into the through hole 16 of the bottom wall 14 of the top rail 12. In the course of their passage through the through hole 16, three said resilient wings 66 are squeezed and thus contracted inward until they get out of the through hole 16. As soon as they get out of the through hole 16, three said resilient wings 66 unfold outward under their intrinsic resilient restoring force and thus engage with the top side of the bottom wall 14 of the top rail 12. At this point, the extension portion 67 of the peripheral wall 64 is penetratingly disposed in the through hole 16 of the bottom wall 14 of the top rail 12, and the blocking flanges 68 of the peripheral wall 64 engage with the bottom side of the bottom wall 14 of the top rail 12. At this point, the cord-penetrating component 60 is fixed in place. The second embodiment is identical to the first embodiment in terms of the relation H1:H2 which the relationship between the cord-penetrating component 60 mounted on the top rail 12 and the reeling unit 22 satisfies.

In conclusion, owing to the ratio of the height of the cord-penetrating component 50, 60 to the height of the reeling unit 22, the cords 36 are wound onto the reeling wheels 30 steadily and smoothly, the cords 36 from different coils neither interfere with each other nor become twisted together, allowing the blind 20 to unfold and fold steadily. The cord-penetrating component 50, 60 of the present disclosure is not necessarily composed of the plastic body 51, 61 and the annular element 58, 69 but can be integrally formed from a wear resistant material.

What is claimed is:

1. A cord-penetrating component for use with a window shade, the window shade comprising a top rail, a reeling unit and a cord, the top rail having a bottom wall, the bottom wall having a through hole penetrable by the cord, the reeling unit being disposed in the top rail and having a top plate, a bottom plate and a reeling wheel disposed between the top plate and the bottom plate, the cord being disposed at the reeling wheel and driven by the reeling wheel so as to be wound on to the reeling wheel, wherein the cord-penetrating component is disposed on the bottom wall of the top rail, protrudes from the top side of the bottom wall of the top rail, and has a guide hole penetrable by the cord, wherein H1 denotes a vertical distance between the bottom side of the top plate of the reeling unit and the top side of the bottom plate of the reeling unit, and H2 denotes a vertical distance between the top side of the cord-penetrating component and the top side of the bottom wall of the top rail, where H1:H2=2−5:1.

2. The cord-penetrating component for use with a window shade according to claim 1, further comprising an annular wall, at least two opposing first arcuate peripheral walls and at least two opposing second arcuate peripheral walls, the annular wall having the guide hole, the at least two first arcuate peripheral walls being of a larger outer diameter than the at least two second arcuate peripheral walls, wherein the at least two first arcuate peripheral walls and the at least two second arcuate peripheral walls alternately connect to an outer edge of the annular wall, bottom ends of the at least two first arcuate peripheral walls abut against a top side of the bottom wall of the top rail, bottom ends of the at least two second arcuate peripheral walls each have an extension portion and a hook portion extending outward from a terminal end of the extension portion, the extension portions of the at least two second arcuate peripheral walls are penetratingly disposed in the through holes of the bottom wall of the top rail, and the hook portions of the at least two second arcuate peripheral walls engage with the bottom side of the bottom wall of the top rail, wherein H2 denotes a vertical distance between the top side of the annular wall and the top side of the bottom wall of the top rail.

3. The cord-penetrating component for use with a window shade according to claim 2, further comprising a plastic body and an annular element, the plastic body having the annular wall, the at least two first arcuate peripheral walls and the at least two second arcuate peripheral walls, the annular element being disposed on the annular wall of the plastic body and surrounding the guide hole.

4. The cord-penetrating component for use with a window shade according to claim 1, further comprising an annular wall and a peripheral wall, the annular wall having the guide hole, the peripheral wall connecting to an outer edge of the annular wall, the peripheral wall having at least two opposing slits, the at least two slits extending from a bottom end of the peripheral wall toward the annular wall to allow a resilient wing to be formed between the at least two slits, the resilient wing abutting against the top side of the bottom wall of the top rail, wherein the bottom end of the peripheral wall has an extension portion and a blocking flange extending outward from a terminal end of the extension portion, the extension portion of the peripheral wall is penetratingly disposed in the through hole of the bottom wall of the top rail, and the blocking flange of the peripheral wall engages with the bottom side of the bottom wall of the top rail, wherein H2 denotes a vertical distance between the top side of the annular wall and the top side of the bottom wall of the top rail.

5. The cord-penetrating component for use with a window shade according to claim 4, further comprising a plastic body and an annular element, the plastic body having the annular wall and the peripheral wall, the annular element being disposed on the annular wall of the plastic body and surrounding the guide hole.

6. A window shade, comprising:
a bottom rail;
a top rail having a bottom wall, the bottom wall having a through hole;
a blind disposed between the top rail and the bottom rail;
a reeling unit disposed in the top rail and having a top plate, a bottom plate and a reeling wheel disposed between the top plate and the bottom plate;
a cord with an end passing through the through hole of the bottom wall of the top rail and the blind and connecting to the bottom rail and with another end connecting to the reeling wheel; and
a cord-penetrating component disposed on the bottom wall of the top rail, protruding from the top side of the bottom wall of the top rail, and having a guide hole penetrable by the cord;
wherein H1 denotes a vertical distance between the bottom side of the top plate of the reeling unit and the top side of the bottom plate of the reeling unit, and H2 denotes a vertical distance between the top side of the cord-penetrating component and the top side of the bottom wall of the top rail, where H1:H2=2−5:1.

7. The window shade of claim 6, wherein the cord-penetrating component has an annular wall, at least two opposing first arcuate peripheral walls and at least two opposing second arcuate peripheral walls, the annular wall has the guide hole, the at least two first arcuate peripheral walls and the at least two second arcuate peripheral walls alternately connect to an outer edge of the annular wall, the at least two first arcuate peripheral walls are of a larger outer diameter than the at least two second arcuate peripheral walls, bottom ends of the at least two first arcuate peripheral walls abut against the top side of the bottom wall of the top rail, bottom ends of the at least two second arcuate peripheral walls each have an extension portion and a hook portion extending outward from a terminal end of the extension portion, the extension portions of the at least two second arcuate peripheral walls are penetratingly disposed in the through holes of the bottom wall of the top rail, the hook portions of the at least two second arcuate peripheral walls engage with the bottom side of the bottom wall of the top rail, wherein H2 denotes a vertical distance between the top side of the annular wall and the top side of the bottom wall of the top rail.

8. The window shade of claim 7, wherein the cord-penetrating component has a plastic body and an annular element, the plastic body having the annular wall, the at least two first arcuate peripheral walls and the at least two second arcuate peripheral walls, the annular element being disposed on the annular wall of the plastic body and surrounding the guide hole.

9. The window shade of claim 6, wherein the cord-penetrating component has an annular wall and a peripheral wall, the annular wall has the guide hole, the peripheral wall connects to an outer edge of the annular wall, the peripheral wall has at least two opposing slits, the at least two slits extend from a bottom end of the peripheral wall toward the annular wall to allow a resilient wing to be formed between the at least two slits, the resilient wing abutting against the top side of the bottom wall of the top rail, the bottom end of the peripheral wall has an extension portion and a blocking flange extending outward from a terminal end of the extension portion, the extension portion of the peripheral wall is penetratingly disposed in the through hole of the bottom wall of the top rail, and the blocking flange of the peripheral wall engages with the bottom side of the bottom wall of the top rail, where H2 denotes a vertical distance between the top side of the annular wall and the top side of the bottom wall of the top rail.

10. The window shade of claim 9, wherein the cord-penetrating component has a plastic body and an annular element, the plastic body has the annular wall and the peripheral wall, the annular element is disposed on the annular wall of the plastic body and surrounds the guide hole.
